(19) United States
(12) Patent Application Publication
(10) Pub. No.: US 2002/0174061 A1
(43) Pub. Date: Nov. 21, 2002

(54) Method and apparatus for intelligent, scalable communications in a multi-asset financial fulfillment network

(76) Inventors: Venkatesan Srinivasan, Framingham, MA (US); Sanjay Mithal, New York, NY (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/010,768

(22) Filed: Dec. 4, 2001

Related U.S. Application Data
(60) Provisional application No. 60/251,077, filed on Dec. 4, 2000.

(51) Int. Cl. G06F 17/60

(52) U.S. Cl. 705/38

(57) ABSTRACT

A method and system for providing scalable communication capabilities in a financial fulfillment network. Computer systems external to the financial fulfillment network may communicate with each other and with the network using a uniform interface, such as an Applications Programming Interface (API). The API may allow systems communicating with and within the network to structure messages in a uniform and predictable way depending on the purpose for communications. A set of information packets may be assembled in suitable sets, and used to structure the content of messages related to a plurality of different purposes, such as different financial services. Interactive communication between systems is also supported, e.g., while a financial transaction is ongoing.

### CROSS REFERENCE TO RELATED APPLICATIONS

This application hereby incorporates U.S. Application Ser. No. 09/684,208, filed Oct. 6, 2000, by reference in its entirety. This application claims the benefit under 35 U.S.C. § 119(e) of the filing date of U.S. Provisional Application No. 60/251,077, filed Dec. 4, 2000, which is hereby incorporated by reference in its entirety.

### FIELD OF THE INVENTION

The present invention relates generally to a method and apparatus for providing uniform, intelligent, and scalable communications between disparate entities on a multi-asset, financial fulfillment network.

### DESCRIPTION OF RELATED ART

Computers in networks interconnecting disparate businesses, such as networks including two or more computer systems that communicate with each other to perform various functions such as loan processing and other financial transactions, typically do not (or cannot be counted on to) communicate using a single, standard messaging protocol, data format, or document format. As a result, the computer system of an entity, such as a lending institution, may have to be specially configured to communicate with each of potentially many different computer systems to send, receive, and appropriately respond to information from other systems. For example, if a merchant wishes to submit a loan application electronically to several different lenders using the merchant's computer system, the merchant's computer system may have to be configured specially to format or otherwise package the loan application information in a different way for each lender's computer system to which the application is sent. In addition, the merchant's computer system would have to incorporate the capability to interact with the lender's remote computer system in order to fulfill requirements that are unique to a particular lender in order to complete the credit application. Furthermore, these interactions would have to be customized for each type of credit application, e.g., loan, lease, etc., because of the disparate information requirements of these products. These requirements may make it difficult for a merchant or other entity to access financial services and may discourage the merchant or other entity from even attempting to access the financial services of others using electronic means.

### SUMMARY OF THE INVENTION

Illustrative embodiments of the invention provide a variety of different aspects that combine to provide a widespread and scalable electronic financial fulfillment network that may be accessed by a number of different computer systems. In one illustrative embodiment, communication between computer systems external to a financial fulfillment network and systems within the financial fulfillment network may be managed using a Financing Application Programming Interface (API). The financial fulfillment network, such as a financing system described in U.S. patent application Ser. No. 09/684,208, filed Oct. 6, 2000 and titled “Method and Apparatus for Processing Financing Applications”, may include a computer system or network of computer systems that operate financing service modules and communicate with external systems. That is, such a computer system may, for example, handle requests for financial services from the external systems and responses to the requests. The financing service modules may provide any suitable financing service, such as processing factoring transactions, trade credit transactions, leasing transactions, escrow transactions, credit insurance transactions, letter of credit transactions, credit card transactions, payment netting, funds transfer, aspects of any of them, and so on. As one example, a loan application processing module operating within the financial fulfillment network may automatically process a loan application submitted by an external computer system in a financial services request and send a decision to approve or decline the application back to the external computer system. The financing service modules may be operated on behalf of lending institutions or other entities that have authorized their financing service decisioning logic to be implemented within the financial fulfillment network.

In one aspect of the invention, a Financing API may be configured such that all communications between external computer systems and the financial fulfillment network are formatted based on a uniform set of messaging rules, i.e., the messaging protocol used between the communicating devices reflects a set of predefined message portions (or information packets (not to be confused with the use of the term “packet” in a networking sense; thus, an “information packet” may be transmitted in a non-packetized format or if in a packetized format, as one, more than one or less than one packet on a communications channel or network)), specialized to facilitate the clearing of the financing transactions and available to system users as a common interchange language. The message portions themselves are relatively insensitive to the sequence and/or combinations in which they are invoked, allowing for a multitude of behaviors on the part of disparate on-line users/applicants. For example, the message portions may be combined in a variety of different ways to form a variety of different messages, thereby allowing the Financing API to support a variety of different financial services.

Furthermore, in another aspect of the invention, the set of message portions that comprise the Financing API are collectively exhaustive, in that they uniquely define the allowable user cases, manifested by users of a variety of financial services transactions. Thus, even though different external computer systems may use different operating systems and/or different financing transaction applications (such as loan application decisioning applications), the external computer systems may all communicate with the financial fulfillment network and may communicate with each other through the financial fulfillment network. This ability to communicate in a uniform way with the financial fulfillment network, i.e., by using a same API, may allow an entity to access the financing services of the network itself as well as the financing services of other entities having external computer systems that communicate with the financial fulfillment network and potentially other financial networks.

In another aspect of the invention, a Financing API may be structured to allow functionality to be added to the financial fulfillment network, e.g., additional financing services, without requiring any change to the messages or message portions used by the Financing API, or at least without requiring substantial change to the messages or message portions. For example, if a new financing service is added to the financial fulfillment network, existing sets of messages or message portions in the API may be used to support the new financing service. In some cases, a new financing service may require one or more new messages or message portions to be added to those supported by the API, but in general the new financing service can be supported in large part by existing messages and/or message portions or combinations of message portions in the API.

In another aspect of the invention, the Financing API has a hierarchical structure that is used to structure the content of communications regarding a financing service provided through the financial fulfillment network. For example, the hierarchy may include the top-down levels of (1) overall or high-level type of financing service requested (self-finance decisioning, financing by outside entities, etc.), (2) type of customer (consumer, business, etc.), (3) type of asset financed (equipment financing, trade financing, etc.), (4) type of credit products available (loan, lease, etc.), (5) sets and/or sequences of operations to be performed (i.e., communications operations needed to provide the financial service), (6) specific operations details, and (7) information packets to be used in the communications (e.g., specific variables or other pieces of information needed to provide the service). Thus, communications for each financing services transaction can be logically organized using a hierarchy to define the parameters of the financing services to be provided and structure the content of the messages used to provide the service. The hierarchical organization can make a more efficient use of messages or information packets supported by the API (e.g., by allowing customized sets of information packets to be used for a variety of different transactions through the use of different combinations and sequences of a relatively small set of standard information packets) and more easily allow the integration of new financing services into the financial fulfillment network (e.g., alterations may be made in the hierarchy without affecting the operations of previously supported financing services). For example, in one aspect of the invention, an item in a selected level in the hierarchy may define a unique set and/or sequence of items from one or more lower levels in the hierarchy, while items in the lower levels may depend on (i.e., may vary according to) items at levels higher than the selected level in the hierarchy.

In another aspect of the invention, the Financing API may allow for interactive communications to occur during a financial services transaction. This interactive capability may allow a financial service to be tailored to each particular application and reduce inefficiencies in obtaining financial services. For example, a remote loan processing system operating with the financial fulfillment network may be configured to intelligently request the applicant to supply additional information beyond that provided in an initial loan application, and incorporate this additional information in making the ultimate credit decision connected with the application. Further, the remote loan processing system may also allow the applicant to interactively monitor the status of the decision associated with the application for credit, providing appropriate responses to ad-hoc user queries.

In an illustrative embodiment, a merchant may submit a loan application to a financial fulfillment network using the Financing API request format. The API request format may be structured, for example, so that the loan application information is provided in a uniform way using a set of organized information packets regardless of the entity or computer system submitting the information. Upon receiving the request from the merchant, the financial fulfillment network may process the request, e.g., submit the data associated with the loan application to a loan application decision process and respond with a decision that is relayed back to the applicant via appropriate Financing API messages. This method of seamless data transfer between possibly disparate computer systems, in which the data from the applicant's computer, via the Financing API request interface, is incorporated into a process automation system operating within the financial fulfillment network, allows for intelligent and scalable communication. Furthermore, the Financing API allows for internal rules-based engines to incorporate information received by the host system via the Financing APIs into the credit approval logic to approve or decline a loan application, and update internal data storage devices with the received information. In addition, the Financing API allows for the loan processing engine residing on the financial fulfillment network to interactively request additional information from the applicant, or from other systems (either third party, or internal) that contain relevant data with which to enhance the quality of the credit decision process. The rules associated with the credit decision process may be arbitrary, in that they are completely specified on the financial fulfillment network by the underwriters of the credit application, or they may include routing rules in which the information required for the credit decision is forwarded to a set of financial institutions that may underwrite the application via the Financing API. In addition to processing a financial services request entirely within the financial fulfillment network, other external computer systems (e.g., computer systems operated by various financing institutions) may receive a services request, process it, and send a response back to the merchant through the financial fulfillment network using the Financing API. Thus, even though the merchant and the financing institutions may operate computer systems and/or applications that are quite different, the Financing API may allow the merchant to access the financing services of the financial fulfillment network and/or other entities having systems that communicate with the financial fulfillment network without requiring otherwise special communications formatting.

Although in the illustrative embodiment above the merchant submits a loan application, the financial fulfillment network and/or other external computer systems may be configured to handle any type of financing transaction including, but not limited to, a factoring transaction, a trade credit transaction, a leasing transaction, an escrow transaction, a credit insurance transaction, a letter of credit transaction, a cash transaction or any combination of these transactions, and other transactions as will occur to those skilled in the field of finance.

Use of the Financing API to communicate with a financial fulfillment network may provide benefits to operators of computer systems external to the financial fulfillment network since the external systems may operate using any suitable operating system, hardware, software, logic, or other components and still be able to obtain and provide financing services through the financial fulfillment network. So long as the external computer system can send and receive communications with the financial fulfillment network, the external computer system can communicate with any other system linked to the financial fulfillment network as well as the network itself. In addition, financing service features may be added or changed in the external computer systems without requiring any change in the API. Thus, an operator of an external computer system may receive and provide different financing services without requiring any change in the API, or may enhance the offering of different financing services by adding to the set of messages defined in the Financing API. Use of the Financing API with the financial fulfillment network also makes the types and/or number of financing services that are available through the network scalable since both the systems in the financial fulfillment network and external systems may add and/or change the financing services provided without any fundamental change in the API being required. For example, a financing institution may initially provide only loan application decisioning services through the financial fulfillment network. As time passes, the institution may add other services, such as factoring services, that are provided through the network. Since the API may support the added services, the institution may need only to add support for messages in the API that are unique to the added services and components, (e.g., hardware, software, etc.) to its computer system and design the added components to be compatible with the API. Further, even if a financing service is added to the financial fulfillment network that requires a change to the API, the API may be relatively easily changed and the altered API used by systems communicating with the financial fulfillment network.

### BRIEF DESCRIPTION OF THE DRAWINGS

Aspects of the invention will be appreciated more fully with reference to the following detailed description of illustrative embodiments, when taken in conjunction with the accompanying drawings, wherein like reference characters denote like features, in which:

FIG. 1 is a schematic block diagram of a computer system incorporating aspects of the invention;

FIG. 2 is a flow chart of steps of a method for communication in accordance with an aspect of the invention;

FIG. 3 shows an illustrative hierarchy for a communications interface in accordance with an aspect of the invention;

FIG. 4 shows an illustrative set of values for levels in the FIG. 3 hierarchy;

FIG. 5 shows an illustrative correspondence between operations and information packets in an illustrative embodiment;

FIG. 6 shows an illustrative implementation of a transaction in an illustrative embodiment; and

FIGS. 7 and 8 show a correspondence between combination information packets and simple information packets in an illustrative embodiment.

### DETAILED DESCRIPTION

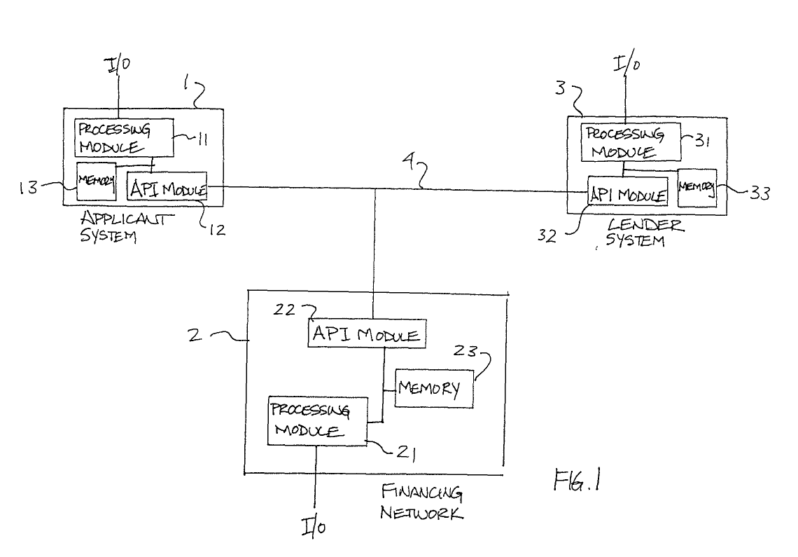

FIG. 1 is a schematic block diagram of an illustrative embodiment that incorporates several aspects of the invention. In this illustrative embodiment, an applicant system 1 accesses financing services offered in connection with a financing network 2 and/or a lender system 3. It should be understood that the illustrative embodiment shown in FIG. 1 is only one example of an arrangement that may incorporate aspects of the invention. For example, any suitable number of applicant systems 1, financing networks 2, and lender systems 3 may be included. Further, the applicant system 1, the financing network 2 and/or the lender system 3 may include any suitable components or functions not described herein whether or not they are related to the operation of any of the systems in accordance with various aspects of the invention.

The applicant system 1, financing network 2 and lender system 3 may be general purpose data processing systems, such as a suitably programmed general purpose computer, or network of general purpose computers, and other associated devices, including communication devices and/or other circuitry or components necessary to perform desired input/output or other functions. The applicant system 1, financing network 2, and lender system 3 can also be implemented, at least in part, as a single special purpose integrated circuit (e.g., an application-specific integrated circuit —ASIC), or an array of ASICs, each having a main or central processor section for overall, system level control and separate sections dedicated to performing various different specific computations, functions and other processes under the control of the central processor section. The applicant system 1, financing network 2, and lender system 3 can also be implemented using a plurality of separate, dedicated programmable integrated or other electronic circuits or devices, e.g., hard-wired electronic or logic circuits, such as discrete element circuits or programmable logic devices. These systems 1, 2, and 3 may also include any other suitable devices, such as one or more information display devices (e.g., a computer monitors or printers), user input devices, such as keyboards, user pointing devices, touch screens or other user interfaces, data storage devices, such as a volatile or non-volatile memory, communication devices or other electronic circuitry or components.

The applicant system 1, financing network 2 and lender system 3 may communicate using a communications link 4. The communications link 4 may include any type of communication system, such as wired or wireless telecommunications networks, radio or infrared communications systems, the Internet, one or more wide-area or local-area networks, optical communications networks, combinations of any of them, and the like. In addition, communications may take place using any suitable format, protocol or other scheme to transmit information through the communications link 4.

In this illustrative embodiment, the applicant system 1 includes at least a processing module 11, an applications programming interface (API) module 12 and a memory 13. The financing network 2 and the lender system 3 similarly include at least a processing module 21 or 31, an API module 22 or 32 and a memory 23 or 33. The processing modules 11, 21 and 31 may be configured in any suitable way and may be similar to, or different from, each other. Likewise, the API modules 12, 22 and 32 may be configured in any suitable way. The processing modules 11, 21 and 31 and the API modules 12, 22 and 32 may be implemented, at least in part, as software modules written in any suitable programming language that are executed on any suitable data processing apparatus in any suitable environment. Alternately, or in combination with the software modules, the processing modules 11, 21 and 31 and the API modules 12, 22 and 32 may be implemented as hard-wired electronic circuits or other programmed integrated or other electronic circuits or devices. The memories 13, 23 and 33 may include any suitable data storage devices, such as magnetic disk or tape storage devices, volatile or non-volatile semiconductor devices, optical disk storage devices, etc.

Using the API modules, the systems may communicate with each other in a way that is independent of the other functions, operating systems or capabilities of the systems. As discussed above, the API modules can structure the content of messages sent between the systems based on a defined purpose for the communications using a set of information packets known to each of the API modules. That is, information that is to be sent between the systems 1, 2 and/or 3 may be associated with one or more appropriate information packets that are then assembled into a message and sent. (As discussed above, the term “information packet” does not refer to packetized transmission protocols. Instead, “information packet” refers to predefined message portions that may be used to structure a message as described in more detail below. Messages generated using “information packets” may be sent by packetized transmission protocols, or not, as the transmission protocol used is not important to this aspect of the invention.) The message may include a header information packet that includes information indicating the defined purpose for communication. The system receiving the message may use the communication purpose information to determine which information packets are included in the message and use the information associated with the information packets for any suitable purpose.

As a brief example described in more detail below, a user of the applicant system 1 may use the system 1 to send a message regarding a loan application to the financing network 2. The user may indicate a purpose for communication, e.g., “loan application”, to the system 1 and then provide information to be sent in a message to the financing network 2. The API module 12 may identify, e.g., select based on a purpose for communication, a set of information packets to be used when constructing the message based on the defined communication purpose “loan application”, and assign information for the message to the appropriate information packets. Once the information to be sent has been properly associated with the information packets to be used to structure the message, the message can be sent to the financing network 2. Since the financing network 2 receiving the message can identify the communication purpose for the message, e.g., from the header information packet, the financing network 2 can determine which information packets are included in the message and retrieve needed information from appropriate information packets or variables.

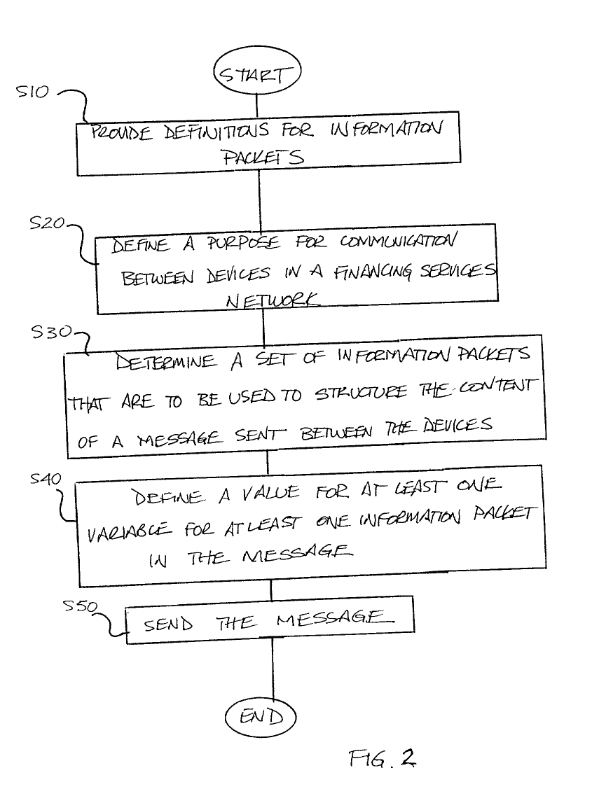

FIG. 2 is a flow chart of steps that may be performed, for example, by any of the applicant system 1, financing network 2 and/or lender system 3 when communicating. Although the illustrative embodiment shown in FIG. 1 is used to help explain the steps in the FIG. 2 flow chart, it should be understood that the steps of this method need not be performed only on a system like that in FIG. 1. Instead, aspects of the invention may be implemented in any suitable environment, system or set of systems.

In step S10, definitions for information packets are provided. The definitions for information packets may be provided in any suitable way, including storing definitions in the memories 13, 23 or 32, sending definitions for information packets from one system to another, e.g., from the financing network 2 to the applicant system 1, or in other manners. In one example used herein to explain an illustrative embodiment, information packet definitions are stored in the memories 13, 23 and 33.

The definitions for the information packets may define a set of variables that are associated with each information packet. For example, definitions may be provided for information packets related to a consumer or business address, asset information, a credit bureau report, consumer or business financial information, a credit reference, employment information, equipment information, a list of alternate identification information for a consumer or business, and others. Any suitable variables, or fields, may be associated with an information packet, e.g., an information packet for a consumer address may be associated with variables for a street, city, ZIP code, country, and phone number. An exemplary set of information packet definitions is provided in Table 1 below and in the incorporated U.S. Provisional Application No. 60/251,077 in sections 6.3 of Documents 1, 2 and 3. An information packet may have one or more variables associated with it, and the variables may have any suitable type, such as number, string, integer, character, a number range, a flag, and so on. Information packets may also reference other information packets in some cases, e.g., an information packet for consumer financial information may be associated with a number of variables as well as an information packet for consumer address information.

In step S20, a purpose for communication between devices in a financing services network is defined. The purpose for communication may be defined in any suitable way. For example, a user of the applicant system 1 may indicate a purpose for communication by inputting information through an input/output (I/O) device, such as a voice recognition system, keyboard, touch screen, a graphical user interface, etc. The information representing the purpose for communication may be input in response to prompting by the applicant system 1, e.g., the applicant system 1 may request the user to indicate whether communications with a financing network 2 are for a loan application or a line of credit. Thus, the purpose for communication may be defined by a single value, representing, for example, “loan application”, “syndication”, “letter of credit”, etc., or by a plurality of values. For example, a hierarchy of values may be used to define the purpose for communication. As discussed above, a first level in the hierarchy may define a financing service to be accessed, a second level may define the type of customer accessing the service, a third level may define the financing option selected for the transaction, and so on. The user may provide information to define the communication purpose in any suitable way, such as by selecting a particular Internet website page (e.g., where each of a plurality of different pages are associated with different communication purposes), by entering information into appropriate areas of a graphical user interface, by selecting a set of values displayed in a graphical user interface, and so on. In another embodiment, the applicant system 1 may extract information from data provided by the user, e.g., in a loan application form, to determine the communication purpose.

Alternately, a purpose for communication may be defined by a communication signal received at any of the systems from another system. For example, the lender system 3 may receive a signal from the financing network 2 that indicates a purpose for communication. The signal may explicitly define one or more parameters that indicate the purpose for communication, or the system receiving the signal may determine the purpose for communication from attributes of a received message, e.g., a received message that includes a loan application may itself represent a purpose for the communication is “loan application”.

In step S30, a set of one or more information packets that are to be used to structure the content of a message sent between the devices is determined. The set of information packets used to structure the content of the message may be determined based on the purpose of communications defined in step S20. Thus, for example, communications relating to a loan application may be structured using a first set of information packets and communications relating to a line of credit transaction may be structured using a second, different set of information packets. If a plurality of parameters is used to define the purpose for communication, the set of information packets used for structuring the content of messages may be selected based on the set of parameters. Since the set of information packets may be determined based on the purpose for a communication, devices receiving messages that participate in communications having a defined purpose can anticipate and/or readily parse information received in a message. This is because the information packets may be drawn from a set of standard information packets, both the set and the structure of each available information packet type being known to the device receiving a message, and each of a plurality of communication purposes may be associated with known sets of information packets as meaningful information. As such, data can be extracted from the information packets in a message and used in proper context.

Each message sent between devices may also include an information packet that includes header information. The API header information packet may include variables associated with information for the sender's identification, a timestamp, a transaction identifier, a return address, as well as values that define the purpose for communication, such as values for different levels in a hierarchy. This header information packet can be used by a receiving device to identify what the purpose for communication is, who sent the message, when and where the message was sent, and so on.

In step S40, a value for at least one variable for at least one information packet in the message is defined. As discussed above, variables associated with an information packet may take any suitable form and may be associated with string-type information, numeric information, etc. Values may be provided in any suitable way for the variables. For example, a user may enter values by keyboard or other user interface, e.g., when completing a loan application form on the applicant system 1. Values may also be obtained from other information sources, such as previously sent messages, a database, such as a consumer credit information bureau, and so on. Thus, a user need not provide all of the information used to define values for variables associated with an information packet.

In step S50, the message is sent, e.g., from one device to another in a financing services network. The message need not be sent directly between devices, and instead may be sent, for example, from an applicant system 1 to a financing network 2, which then forwards the message, or a similar message to the lender system 3. As discussed above, the message may be sent in any suitable way using any suitable protocol and/or communication channel. For example, the message may be sent through a telecommunications network, the Internet, a local area or wide area network, whether wired or wireless, or any suitable combination of such systems.

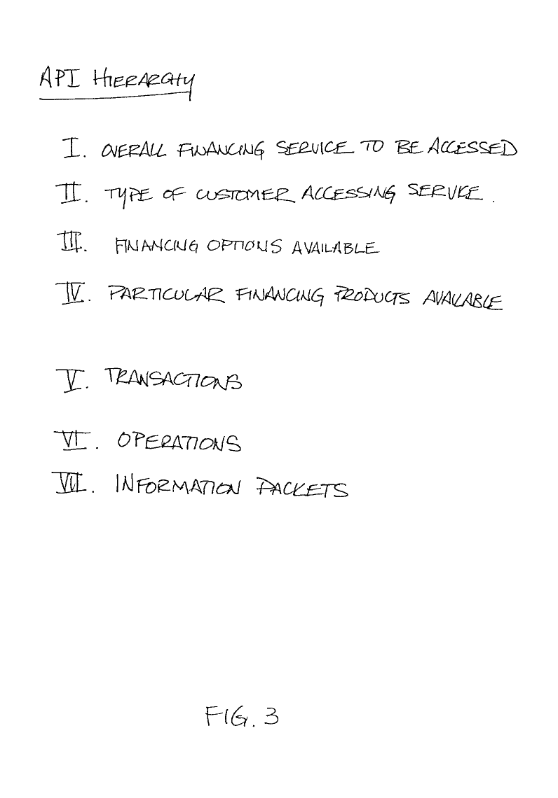

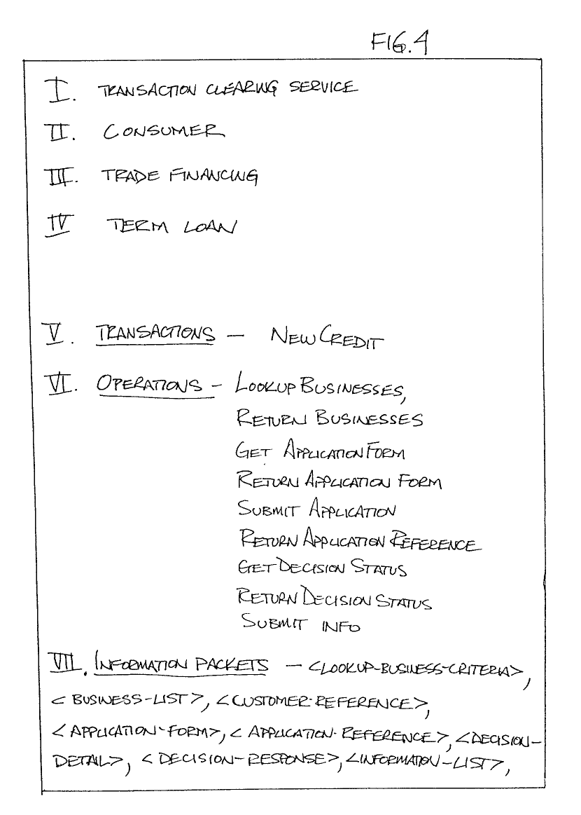

To further illustrate several aspects of the invention, an illustrative embodiment is described below in which the FIG. 1 system is used to communicate regarding a financing transaction. In this embodiment, the API modules 12, 22, 32 use a 7-level hierarchy shown in FIG. 3 to define a purpose for communication. Level I in the hierarchy is an overall financing service to be accessed by a user of the applicant system 1, which may include a transaction clearing service (such as a loan application decisioning service, syndication service, etc.), authentication services (such as a service to verify the true identity of a particular consumer or business or to detect credit or other fraud), or payment services (such as credit card or other debt payment services). In this illustrative embodiment, the user accesses a graphical user interface (GUI) that presents value options for Level I that the user selects. By selecting a value for levels in the hierarchy, the user can define a purpose for communication. FIG. 4 shows values selected by/for the user in this illustrative embodiment. For this transaction, the user has selected the value “Transaction Clearing Service” for Level I in the hierarchy. Values selected in certain levels in the hierarchy may affect the possible values that may be selected or otherwise defined for other levels. For example, certain options may not be available to certain types of customers or for certain types of financing services. Thus, if the user selects values from a graphical user interface to define a purpose for communication, the selectable values displayed by the graphical user interface for other levels may be adjusted based on one or more defined values in the hierarchy.

Level II in this example relates to the type of customer accessing the financing service, such as a consumer or business type customer. The customer types in this level may be further broken down into customer types in addition to the business and consumer types. For example, the business type may be broken down into small, medium and large business sizes, etc. Such further breakdowns for items in various levels of the hierarchy may be made within the level itself, or in other sublevels. For example, Level II may provide for the types “consumer” and “business”, and a sublevel IIA may be provided for the customer subtypes of small, medium and large businesses. This general notion applies to all levels in the hierarchy, not just Level II in this specific example. In FIG. 4, the user has selected the value “Consumer” for Level II in this transaction.

Level III in this example relates to financing options for the customer. Such options may include trade financing, working capital financing, equipment financing and other financing options. Financing options that involve a form of lending may include secured and/or unsecured forms of lending. In FIG. 4, the user has selected the value “Trade Financing” for Level III.

Level IV of the hierarchy includes items related to particular financing products that are available to the customer. As with any of the other levels in the hierarchy, items in Level IV of the hierarchy may be dependent upon values in other levels in the hierarchy. For example, particular financing products may be available to business type customers (Level II), but not to consumer type customers. Similarly, the types of available financing products may depend upon a selected financing option from Level III. In this illustrative embodiment, available financing products may include single payment loans, term loans, installment loans, revolving loans, a line of credit, letter of credit, and so on. In the example shown in FIG. 4, the user has selected the value “Term Loan” for Level IV.

The hierarchy also includes Levels V, VI and VII. These levels in the hierarchy define transactions (Level V) that are to be performed based on values for at least one of Levels I-IV, operations (Level VI) that are performed for each transaction, and information packets (Level VII) that are used in performing the transactions and operations. In this illustrative embodiment, the user does not select, adjust or otherwise directly define values for Levels V-VII, although it may be possible for the user to define values for Levels V-VII. Instead, these values are defined by the API module 12, 22 or 32. Any one of Levels V, VI and VII may depend upon other levels in the hierarchy. For example, in this illustrative embodiment, the transactions level in the hierarchy depends upon values in Levels I-IV, the operations level depends upon the transactions level, and the information packets level depends upon Levels II-IV and VI in the hierarchy.

Values for the Levels I-IV in the example shown in FIG. 4 require the transaction NewCredit (Level V) to be implemented. In this example, the transaction NewCredit requires the operations LookupBusinesses, ReturnBusinesses, GetApplicationForm, ReturnApplicationForm, SubmitApplication, ReturnApplicationReference, GetDecisionStatus, ReturnDecisionStatus, and SubmitInfo. Since the operations level items depend upon the transactions level (Level V), a given transaction, such as NewCredit, will always require the same set of operations. Thus, it is possible for other value sets for Levels I-IV of the hierarchy to require the transaction NewCredit to be implemented. In this example, other value sets that require the transaction NewCredit will always require the same set of operations. However, it will be understood that dependencies in this illustrative embodiment may be altered in any suitable way.

The information packets needed to implement the transaction NewCredit are also listed in FIG. 4. In this example, the items at the information packets level (Level VII) depend upon at least one upper level in the hierarchy, such as Levels II-V. For example, different information packets may be used to implement the transaction NewCredit and its associated operations depending on whether the customer is a Consumer or Business customer as indicated in Level II in the hierarchy. Similarly, a different set of information packets may be used to implement the transaction NewCredit depending upon values for other levels in the hierarchy, such as Levels III and IV.

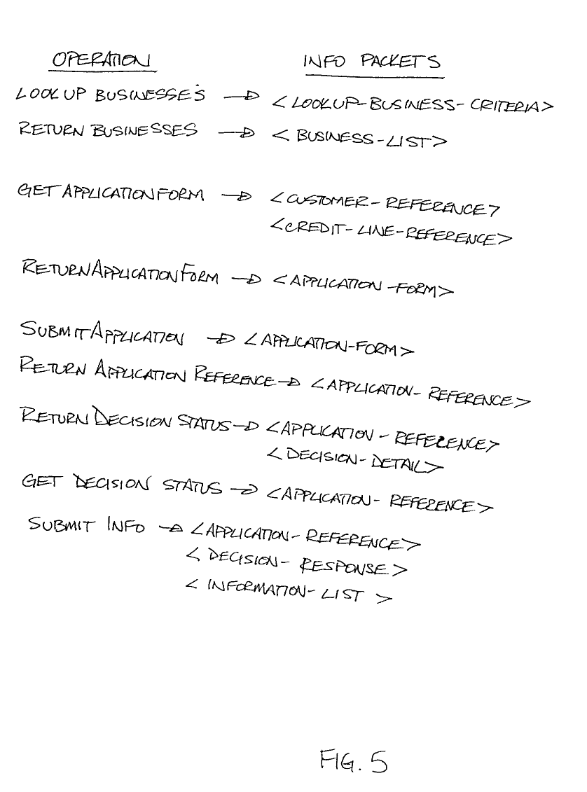

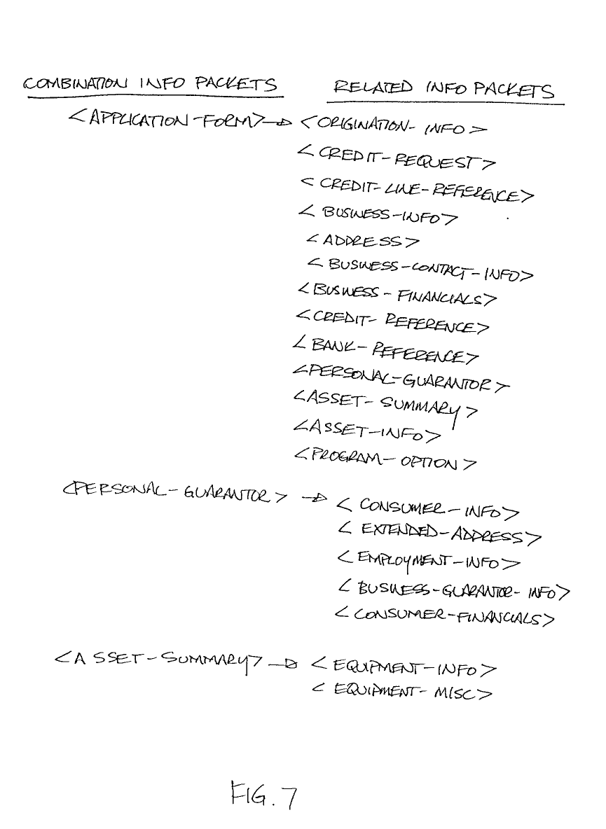

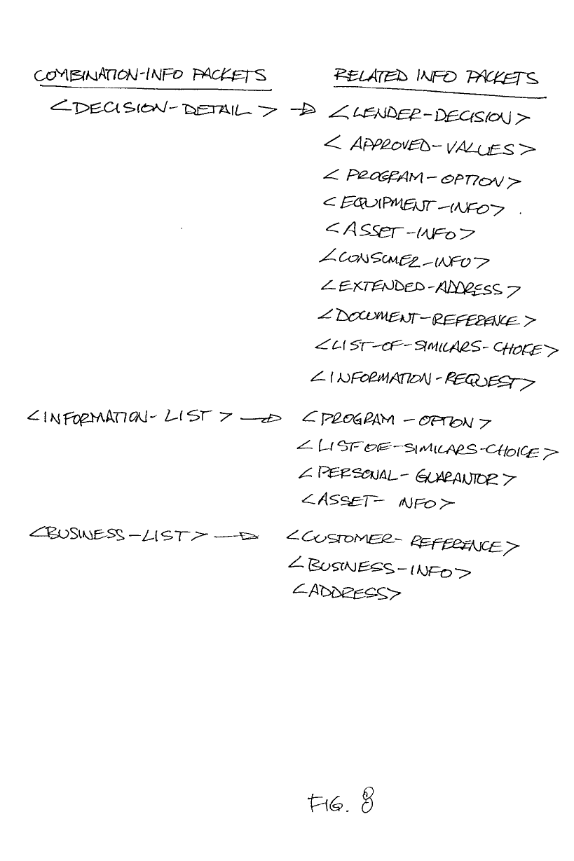

FIG. 5 shows an exemplary correspondence between the information packets used and each operation executed to implement the NewCredit transaction in this embodiment. For example, the LookupBusinesses operation requires the information packet <lookup-business-criteria>and so on. Thus, this correspondence shows which information packets will be used when performing each corresponding operation in the transaction NewCredit. Several of the information packets listed in FIG. 5 as corresponding to a particular operation are actually combination information packets that refer to two or more information packets. This shorthand form is not required and is used to simplify the presentation in FIG. 5 by eliminating the need to include a list of several information packets for each operation. FIGS. 7 and 8 provide a complete list of information packets that relate to each combination information packet in this illustrative embodiment. Further information regarding the fields, or variables, that may be associated with each information packet in this illustrative embodiment are provided in the incorporated U.S. Provisional Application Serial No. 60/251,077, e.g., in section 6.3 of Documents 1-3 in the provisional application.

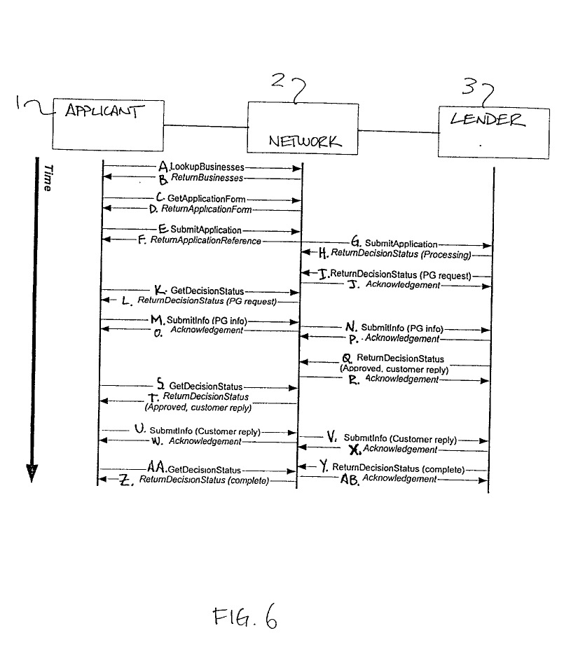

FIG. 6 shows a set of messages that are sent between an applicant system 1, financing network 2 and a lender system 3 in an illustrative embodiment when executing the transaction NewCredit. The set of messages sent as shown in FIG. 6 occurs after a purpose for communication has been defined, e.g., by the user entering values for one or more levels in Levels I-IV of the hierarchy shown in FIG. 3. As discussed above, a user at the applicant system 1 may define the purpose for communication, for example, by selecting values in a graphical user interface for different levels in the hierarchy. The purpose for communication in this example is that shown in FIG. 4. The purpose for communication may be represented by values from Levels I-VI in the hierarchy that are included in message header information packets. Once the purpose for communication is defined, the API module 21 may identify the transaction(s), operation(s) and information packet(s) to be used to structure messages sent when performing the transaction. Thus, in a first communication (Communication A) in implementing the transaction NewCredit as shown in FIG. 6, a LookupBusinesses operation is performed. In general, each operation included in this illustrative embodiment involves sending a single message, but operations may include sending/receiving two or more messages and/or other functions. In this example, the LookupBusinesses operation involves sending a message from the applicant system 1 to the financing network 2 including the corresponding information packet <lookup-business-criteria>as well as an API header information packet. This message set may be used to request the financing network 2 to search a database for information related to the consumer requesting the financing services. For example, the consumer may be an individual wishing to purchase a good or service from a merchant that maintains the applicant system 1. Merchant personnel may use the LookupBusinesses operation to request the financing network 2 to retrieve stored information related to the consumer. The financing network 2 implements the ReturnBusinesses operation and sends back a message (Communication B) that includes information identified in the search requested in the LookupBusinesses operation. As with the other messages sent when implementing an operation, the information contained in the message is structured using the information packets associated with the operation being performed. The message may include no information, e.g., if the financing network 2 did not find any records meeting the search criteria, or a list of one or more records that met the search criteria.

A user at the applicant system 1 may use information in the message sent from the financing network 2 to carry the transaction forward, e.g., select a record provided in the ReturnBusinesses message that relates to the consumer and use the information in the record to complete an application form. Alternately, if the ReturnBusinesses message did not include any information related to the consumer, or if the LookupBusinesses message was never sent (e.g., in the case that the user knows that the financing network 2 does not include any information related to the consumer), the message (Communication C) sent when implementing the GetApplicationForm operation may request a blank application form related to the requested financing service. The message may include an indication of which information sent with the ReturnBusinesses message relates to the applicant. The financing network 2 may send back the ReturnApplicationForm message (Communication D) that includes the blank application form. Not necessarily all of the fields in the blank application form may be empty. Instead, any suitable number of the fields may be filled in by the financing network 2 using appropriate information, such as information identified in the GetApplicationForm message as relating to the applicant, and so on, before sending the form to the application system 1.

After receiving the application form, the user may provide information to complete the application, e.g., by typing information into appropriate areas of a graphical user interface. Once the application form is complete, the SubmitApplication message (Communication E) may be sent to the financing network 2. The ReturnApplicationReference message (Communication F) may be sent back to the applicant system 1 to acknowledge receipt of the application and possibly indicating other information, such as reference information for the application, such as an application number.

The financing network 2 may also send a SubmitApplication message (Communication G) to one or more lender systems 3, thereby submitting the application to one or more lenders for consideration. This SubmitApplication message may have the same structure as the SubmitApplication message received from the applicant system 1. This capability allows the application to easily be sent to multiple lender systems 3 if desired, since no special processing is required for each message sent to a lender. The lender system 3 may return a ReturnDecisionStatus message (Communication H) acknowledging the application submission and communicating the lender system 3's current status, e.g., currently processing application. As needed, the lender system 3 may send additional ReturnDecisionStatus messages (Communication I) to the financing network 2, for example, to request additional information such as a personal guarantor for the applicant requesting the loan. The financing network 2 may acknowledge the message, e.g., by sending the Acknowledge message (Communication J).

At any point in the process, the applicant system 1 may send a GetDecisionStatus message (Communication K) to the financing network 2 to check on the current status of the loan application for a plurality of lenders. The financing network 2 may return a ReturnDecisionStatus message (Communication L) that includes any suitable information, such as a status last reported by the lender system 3, an information request, such as the personal guarantor (PG) request sent in Communication I, and so on. In response to a ReturnDecisionStatus message that requests further information, the applicant system 1 may send a SubmitInfo message (Communication M) that includes the requested information. The financing network 2 may acknowledge receipt of the SubmitInfo message and forward the SubmitInfo message (Communication N) to the appropriate lender system 3. This type of interactive communication capability is a unique aspect of this illustrative embodiment. Thus, a lender system 3 need not simply reject an application, but instead may request further information, such as an adjustment in loan terms, guarantor information, and so on to allow approval of the application.

Once the application is approved, a ReturnDecisionStatus message (Communication Q) may be sent from the lender system 3 to the financing network 2, which may acknowledge receipt of the message (Communication R) and forward it (Communication T) to the applicant system 1 either on its own or in response to a GetDecisionStatus message (Communication S) sent by the applicant system I to the financing network 2. The customer may accept the lender's approval in a SubmitInfo message (Communication U) sent to the financing network 2, which may forward the SubmitInfo message (Communication V) to the lender system 3. The lender system 3 may acknowledge the transaction is complete with a ReturnDecisionStatus message (Communication Y) that may be acknowledged by the financing network 2 and forwarded to the applicant system 1 (Communication Z).

It should be understood that the above description is only one illustrative example for one transaction that may be executed by the illustrative embodiment. It should be understood that various aspects of the invention should in no way be limited to this or other examples provided herein.

Although particular embodiments of the invention are described in detail, various modifications and improvements will readily occur to those skilled in the art. Such modifications and improvements are intended to be part of this disclosure and within the spirit and scope of the invention. Accordingly, the description of the illustrative embodiments is by way of example only and the invention is defined, at least in part, by the following claims and their equivalents.

TABLE 1

| | | | | |
|---|---|---|---|---|
| Field | Description | Domain | Req | Validation |

<acknowledgement>
An information packet that contains a response acknowledgement plus any completion
codes

| | | | | |
|---|---|---|---|---|
| Sender Id | eCredit.com assigned id for the | Char 10 | Y | |
| | sender of the request or notify | | | |
| | message | | | |
| Event Id | Unique id for the request or | Char 10 | Y | |
| | notify message. | | | |
| Completion | Level of error | Char 10 | Y | Completion Code list |
| Code | | | | |
| Message | Completion message text | Char | N | |
| | | 100 | | |

<address>

| | | | | |
|---|---|---|---|---|
| Address 1 | The first address line | Char 30 | Y | |
| Address 2 | Additional address line | Char 30 | N | |
| City | | Char 30 | Y | |
| State/Province | | Char 10 | Y | State Abbreviation |
| | | | | list |
| Zip/Postal Code | | Char 10 | Y | |
| Country | Country | Char 30 | Y | Country list |
| Phone | Phone number | Char 13 | N | Required for |
| | | | | <business-address> |
| Phone | | Char 13 | N | |
| Extension | | | | |

<api-header>
This is the standard information packet for all API messages.

| | | | | |
|---|---|---|---|---|
| API Version | API version for this message | Char 2 | Y | “2” for V3.1 |
| Sender Id | eCredit.com assigned id for the | Char 10 | Y | |
| | sender of this message | | | |
| Event Id | Unique id for this message. | Char 10 | Y | Unique Id provided by |
| | | | | the Sender |
| Event | The local date and time that the | Char 20 | Y | Format: |
| Submission | sender submitted this message | | | “yyyymmdd hh:mm:ss” |
| Timestamp | | | | |
| Event Time | The time zone where this | Char 6 | Y | ±HH:MM. |
| Zone | message is submitted expressed | | | EST = “−05:00”, |
| | as the time difference from | | | CST = “−06:00”, |
| | Coordinated Universal Time | | | MST = “−07:00”, |
| | (UTC). | | | PST = “−08:00”. This |
| | | | | should be adjusted for |
| | | | | Daylight Savings Time |
| | | | | where applicable. |
| GFN Site Id | The GFN site where this | Char 10 | N | |
| | application is being processed. | | | |
| Return IP | Return address of the site where | Char 255 | N | format: |
| Address | this message originated. This | | | “xxx.xxx.xxx.xxx” for |
| | could be an IP address or a URL. | | | a return IP address. |
| Service Type | eCredit.com code for this type of | Char 30 | Y | Service list |
| | service | | | |
| Customer Type | eCredit.com code for this type of | Char 30 | Y | Customer list |
| | customer | | | |
| Form Factor | eCredit.com code for this form | Char 30 | Y | Form Factor list |
| | factor | | | |
| Facility | eCredit.com code for this facility | Char 30 | Y | Facility list |
| | type | | | |
| Transaction | eCredit.com code for this | Char 30 | Y | Transaction list |
| | transaction | | | |
| Operation | eCredit.com code for this | Char 30 | Y | Operation list |
| | operation | | | |
| Merchant Id | eCredit.com assigned id for the | Char 60 | Y | Valid merchant Id |
| | merchant | | | |
| Lender Id | eCredit.com assigned id for the | Char 60 | N | Valid lender Id |
| | lender | | | |
| Application | An id for this application that is | Char 60 | N | |
| Number | unique to the merchant. | | | |

<application-info>

| | | | | |
|---|---|---|---|---|
| Approved | Name of customer approved by | Char 30 | Y | |
| Name | the lender | | | |
| Status | eCreditcom-specific Status | Char 20 | Y | Decision Status list |
| | notification | | | |
| Decision | eCredit.com-specific Decision | Char 20 | Y | Decision list |
| Decision State | eCredit.com-specific Decision | Char 30 | Y | Decision State list |
| | State | | | |

<application-reference>
Provides a reference to the specific application that may be used to get a decision status
or populate an application form.

| | | | | |
|---|---|---|---|---|
| Merchant Id | eCredit.com assigned id for the | Char 10 | Y | Valid merchant Id |
| | merchant | | | |
| Application | An unique id provided by the | Char 10 | Y | |
| Number | merchant for this application. | | | |

<approved-values>
<approved-*> information packets are only provided when the Decision is “Approved”.

| | | | | |
|---|---|---|---|---|
| Submitted | Name of customer as provided | Char 30 | Y | |
| Name | by the merchant | | | |
| Approved | Name of customer approved by | Char 30 | Y | |
| Name | the lender | | | |
| Approved | Address of customer approved | Char 30 | Y | |
| Address | by the lender | | | |
| Approved City | | Char 30 | Y | |
| Approved State | | Char 10 | Y | |
| Approved Zip | | Char 10 | N | |
| Approved | Amount of the credit line | Numeric | N | |
| Credit Line | approved by the lender | | | |
| Approved | Date this credit line will lapse if | Char 20 | N | Format: |
| Credit Line | not used. | | | “yyyymmdd |
| Expiry | | | | hh:mm:ss” |
| Authorized | Approved authorization amount | Numeric | N | Required if |
| Amount | | | | Authorization Code is |
| | | | | provided |
| Authorization | The authorization code from the | Char 20 | N | Required if Authorized |
| Code | lender for the approved loan | | | Amount is provided |
| Terms | text of the terms and | Char | N | |
| Conditions Text | conditions for this credit line | 8191 | | |

<asset-info>

| | | | | |
|---|---|---|---|---|
| Asset Type | Type of asset | Char 50 | Y | |
| Asset | The manufacturer of the asset | Char 50 | Y | |
| Manufacturer | | | | |
| Asset | Description of Asset to be | Char 50 | N | |
| Description | financed | | | |
| Asset Model | The model number ofthe asset | Char 50 | Y | |
| Num | | | | |
| Asset Serial | The serial number of the asset | Char 50 | Y | |
| Num | | | | |
| Asset Condition | Condition of Asset | Char 20 | Y | Asset Condition list |
| Asset Quantity | Number of units | Numeric | Y | |
| Asset Cost | Material cost of asset | Numeric | Y | |
| Asset Tax | Sales tax cost of asset | Numeric | N | |
| Asset S&H | Shipping and handling cost of | Numeric | N | |
| | asset | | | |
| Asset Other | Other costs of asset | Numeric | N | |
| Cost | | | | |
| Address 1 | The first address line of the asset | Char 30 | N | |
| | shipping address | | | |
| Address 2 | Additional address line | Char 30 | N | |
| City | | Char 30 | N | |
| State/Province | | Char 10 | N | State Abbreviation |
| | | | | list |
| Zip/Postal Code | | Char 10 | N | |
| Country | Country of the asset shipping | Char 30 | N | Country list |
| Phone | Phone number | Char 13 | N | |
| Phone | | Char 13 | N | |
| Extension | | | | |

<bank-reference>

| | | | | |
|---|---|---|---|---|
| Bank Ref Name | Name of the bank reference | Char 30 | Y | |
| Bank Ref | First name of the officer at the | Char 30 | Y | |
| Officer First | bank | | | |
| Name | | | | |
| Bank Ref | Last name of the officer at the | Char 30 | Y | |
| Officer Last | bank | | | |
| Name | | | | |
| Bank Ref | Phone number for the bank | Char 13 | Y | |
| Phone | officer | | | |
| Bank Ref | | Char 13 | N | |
| Phone | | | | |
| Extension | | | | |
| Bank Ref Date | Date the account was opened | Char 8 | Y | yyyymmdd |
| Opened | | | | |
| Bank Ref Acct | Names on the account at bank | Char 30 | Y | |
| Name | reference | | | |
| Bank Ref Acct | Type of account | Char 30 | Y | Bank Account Type |
| Type | | | | list |
| Bank Ref Acct | Account number at bank | Char 20 | Y | |
| Number | reference | | | |
| Bank Ref Aect | Current balance for the account | Char 20 | N | |
| Balance | | | | |

<bureau-report>

| | | | |
|---|---|---|---|
| Bureau Report | The text of the requested bureau | Char | Y |
| Text | report | 4095 | |

<bureau-report-reference>

| | | | | |
|---|---|---|---|---|
| Bureau Code | Code name for this bureau | Char 30 | Y | Bureau list |
| Bureau Event | GFN-generated unique id for this | Char 30 | Y | |
| Id | bureau request. | | | |
| Bureau Event | The local date and time of the | Char 20 | Y | Format: |
| Submission | bureau request | | | “yyyymmdd |
| Datetime | | | | hh:mm:ss” |

<business-contact-info>
Information about an individual contact at the Business.

| | | | |
|---|---|---|---|
| Contact Last | Name of contact at the customer | Char 30 | Y |
| name | site | | |
| Contact First | | Char 30 | Y |
| Name | | | |
| Contact Phone | Phone number of customer | Char 13 | Y |
| | contact | | |
| Contact Phone | | Char 13 | N |
| Extension | | | |
| Contact Fax | Fax number of customer contact | Char 13 | N |
| Contact Email | Email for the customer contact | Char 40 | N |

<business-financials>
Financial information about the business

| | | | |
|---|---|---|---|
| Annual | Annual revenue for this applicant | Numeric | Y |
| Revenue | | | |
| Business Net | The current net worth of this | Numeric | Y |
| Worth | business | | |
| Checking | The current balance in the | Numeric | Y |
| Balance | business checking account | | |

<business-guarantor-info>

| | | | | |
|---|---|---|---|---|
| Business | Type of relationship between the | Char 30 | Y | Business Relationship |
| Relationship | guarantor and the business | | | list |
| | applicant | | | |
| Percent | Percentage of ownership in the | Numeric | N | |
| Ownership | company | | | |
| Amount Limit | Maximum amount this guarantor | | N | |
| | is willing to guarantee | | | |

<business-info>

| | | | | |
|---|---|---|---|---|
| Legal Name | Name of the business customer | Char 50 | Y | |
| | of merchant | | | |
| DBA Name | Doing business as name | Char 50 | N | |
| Business Tax Id | The federal tax id for this | Char 20 | N | |
| | business | | | |
| Business Ticker | Ticker symbol for this business | Char 20 | N | |
| Business Legal | Type of business such as | Char 40 | Y | Legal Entity Type list |
| Entity Type | corporation, partnership, | | | |
| | proprietorship | | | |
| Business | Type of industry | Char 40 | N | Industry Type list |
| Industry Type | | | | |
| Applicant Duns | Dun and Bradstreet number for | Char 9 | N | |
| No | this customer, if known | | | |
| Business Start | Year that the business started | Char 4 | Y | “YYYY” |
| Year | | | | |

<consumer-financials>

| | | | | |
|---|---|---|---|---|
| Net Worth | Personal net worth of the | Numeric | N | |
| | owner/consumer | | | |
| Annual Income | Annual income of the | Numeric | Y | |
| | owner/consumer | | | |
| Other Income | Any other income earned by the | Numeric | N | Required if |
| | consumer | | | OtherIncomeSource is |
| | | | | provided |
| Other Income | Source of the other income | Char 30 | N | Required if Other |
| Source | earned by the applicant | | | Income is provided |
| Monthly | Monthly housing payment | Numeric | Y | |
| Housing | | | | |
| Payment | | | | |
| Residence Type | Type of residence (owner, renter, | Char 20 | Y | Residence Type list |
| | etc.) | | | |
| Resident Since | Year the consumer moved into | Char 4 | N | |
| | the current residence | | | |

<consumer-info>

| | | | | |
|---|---|---|---|---|
| Salutation | | Char 20 | N | Salutation list |
| First name | Given name of consumer | Char 30 | Y | |
| Middle Initial | Middle initial | Char 5 | N | |
| Last name | Surname of the consumer | Char 30 | Y | |
| Name suffix | The generation name of the | Char 10 | N | Name Suffix list |
| | consumer | | | |
| Month of Birth | Month of the date of birth for the | Char 8 | Y | Format: “MM” |
| | consumer | | | |
| Day of Birth | Day of the date of birth for the | Char 8 | Y | Format: “DD” |
| | consumer | | | |
| Year of Birth | Year of the date of birth for the | Char 8 | Y | Format: “YYYY” |
| | consumer | | | |
| SSN | Social security number of | Char 9 | Y | |
| | consumer | | | |
| Personal Id | Type of personal id presented | Char 20 | N | Personal Id Type list |
| Type | | | | |
| Personal Id | Name of issuer for the personal | Char 30 | N | |
| Issuer | Id | | | |
| Personal Id | Number from the identification | Char 30 | N | |
| Number | document | | | |
| Bureau | If Yes, the consumer has granted | Char 2 | Y | Must be “Y” or “N” |
| Authorization | the lender authorization access | | | |
| Flag | bureau data | | | |
| Email | Email for the consumer | Char 40 | N | |

<credit-line-info>

| | | | | |
|---|---|---|---|---|
| Lender Name | Name of lender approving the | Char 60 | Y | |
| | credit line | | | |
| Credit Line | Amount of the credit line | Numeric | Y | |
| | approved by the lender | | | |
| Credit Line | Date this credit line will lapse if | Char 20 | Y | Format: |
| Expiry | not used. | | | “yyyymmdd |
| | | | | hh:mm:ss” |
| Credit | Amount available in the credit | Numeric | Y | |
| Available | line | | | |
| Annual | The APR for this lease or loan | Numeric | Y | |
| Percentage Rate | | | | |

<credit-line-reference>
Provides a reference to the specific application that may be used to get a decision status
or populate an application form.

| | | | | |
|---|---|---|---|---|
| Lender Id | eCredit.com assigned id for the | Char 10 | Y | Valid lender Id |
| | lender | | | |
| Lender Account | Lender assigned for the | Char 10 | Y | |
| Number | customer | | | |

<credit-reference>
This may be used for either credit reference or trade reference.

| | | | |
|---|---|---|---|
| Credit Ref | Name of the credit reference | Char 30 | Y |
| Name | | | |
| Credit Ref | Contact first name for the credit | Char 30 | Y |
| Contact First | reference | | |
| Name | | | |
| Credit Ref | Contact last name for the credit | Char 30 | Y |
| Contact Last | reference | | |
| Name | | | |
| Credit Ref | Phone number of the credit | Char 13 | Y |
| Phone | reference contact | | |
| Credit Ref | | Char 13 | N |
| Phone | | | |
| Extension | | | |
| Credit Ref Acct | Account number for the credit | Char 20 | N |
| Num | reference, if applicable | | |

<credit-request>
Information about the specific financial details for this credit application

| | | | | |
|---|---|---|---|---|
| Amount | Credit line requested by the | Numeric | Y | |
| Requested | customer. | | | |
| Term | Lease or loan term requested for | Numeric | N | Default: 36 |
| | this application, in months | | | |

<customer-reference>
Provides a reference to the specific customer that may be used to populate a new credit
application form.

| | | | |
|---|---|---|---|
| Customer | An unique id provided by | Char 10 | Y |
| Number | eCredit.com for this customer. | | |

<decision-response>

| | | | | |
|---|---|---|---|---|
| Lender Id | eCredit.com assigned id for the | Char 60 | Y | Valid lender Id |
| | lender | | | |
| Lender | Lender assigned id for this credit | Char 30 | Y | |
| Application | application | | | |
| Number | | | | |
| Customer | The customer's reply to a | Char 30 | N | Customer Reply list |
| Reply | returned lender decision status | | | |

<document-reference>
This information packet represents a handle to a lender-generated document.

| | | | |
|---|---|---|---|
| Document Id | Unique Id number for this | Char | Y |
| | document | 100 | |
| Document | Identifying string to display to | Char | Y |
| Title | the user | 100 | |

<employment-info>

| | | | | |
|---|---|---|---|---|
| Employee | The work phone number of the | Char 13 | Y | Including area code, |
| Work Phone | applicant | | | with no separators. |
| Employee | | Char 13 | N | |
| Work Phone | | | | |
| Extension | | | | |
| Employer | The name of the applicant's | Char 20 | Y | |
| Name | employer | | | |
| Employee Year | The year that the applicant | Char 4 | Y | Integer format: YYYY |
| employment | started working for this | | | |
| started | employer | | | |
| Employee Job | Job title of the employee | Char 20 | Y | Job Title list |
| Title | | | | |

<equipment-info>

| | | | | |
|---|---|---|---|---|
| Equipment | Description of equipment to be | Char 50 | Y | |
| Description | financed | | | |
| Equipment Cost | Total cost of the equipment | Numeric | Y | |
| Equipment Tax | Sales tax cost of equipment | Numeric | N | |
| Equipment | Shipping and handling cost of | Numeric | N | |
| S&H | equipment | | | |
| Equipment | Other costs of equipment | Numeric | N | |
| Other Cost | | | | |
| Address 1 | The first address line of the | Char 30 | N | |
| | equipment shipping address | | | |
| Address 2 | Additional address line | Char 30 | N | |
| City | | Char 30 | N | |
| State/Province | | Char 10 | N | State Abbreviation |
| | | | | list |
| Country | Country of the equipment | Char 30 | N | Country list |
| | shipping | | | |
| Phone | Phone number | Char 13 | N | |
| Phone | | Char 13 | N | |
| Extension | | | | |

<equipment-misc>

| | | | | |
|---|---|---|---|---|
| Security | Security deposit paid for the | Numeric | N | |
| Deposit | equipment | | | |
| Down Payment | Number of months of payment | Numeric | N | Integers 0, 1, 2, etc. |
| | applied as a down payment for | | | |
| | this transaction | | | |
| Down Payment | Credit Card Number to be used | Char 30 | N | Number with no blanks |
| Credit Card | for down payment. | | | or punctuation between |
| Number | | | | the digits |
| Down Payment | Credit Card Expiration Date | Char 10 | N | Format: “mm/yyyy” |
| Credit Card | | | | |
| Expiration Date | | | | |
| Residual | Residual value of the equipment | Numeric | N | |

<extended-address>
This information packet is a parsed version of the <address> information packet. This is
primarily used to support bureau lookups.

| | | | | |
|---|---|---|---|---|
| Street Number | Address street number for | Char 10 | Y | |
| | consumer | | | |
| Predirectional | Street directional such as North, | Char 5 | N | Street Directional list |
| | South, East, West, SE, NW, etc. | | | |
| Street Name | Street name for the consumer | Char 30 | Y | |
| Postdirectional | Street directional such as North, | Char 5 | N | Street Directional list |
| | South, East, West, SE, NW, etc. | | | |
| Street Type | Type of street for the consumer, | Char 30 | Y | Street Type list |
| | e.g., Street, Road, Drive, etc. | | | |
| Address 2 | Second line of address. | Char 30 | N | |
| | Apartment or Unit for consumer | | | |
| | addresses | | | |
| City | | Char 30 | Y | |
| State | | Char 10 | Y | State Abbreviation |
| | | | | list |
| Zip/Postal Code | Postal or zip code for consumer | Char 10 | Y | |
| Country | Country for the consumer | Char 30 | Y | Country list |
| Phone | | Char 13 | Y | |
| Phone | | Char 13 | N | |
| Extension | | | | |

<information-request>

| | | | | |
|---|---|---|---|---|
| Information | Type of information that is being | Char 30 | Y | Information Type list |
| Type | requested | | | |

<lender-decision>

| | | | | |
|---|---|---|---|---|
| Lender Id | eCredit.com assigned id for the | Char 60 | Y | Valid lender Id |
| | lender | | | |
| Lender Contact | Name of the lender contact | Char 30 | N | |
| Lender Contact | Phone number for the lender | Char 13 | N | |
| Phone | contact | | | |
| Lender Contact | | Char 13 | N | |
| Phone | | | | |
| Extension | | | | |
| Lender Account | Lender assigned id for the | Char 30 | N | |
| Number | customer | | | |
| Lender | Lender assigned id for this credit | Char 30 | Y | |
| Application | application | | | |
| Number | | | | |
| Status | eCredit.com-specific Status | Char 20 | Y | Decision Status list |
| | notification | | | |
| Decision | eCredit.com-specific Decision | Char 20 | Y | Decision list |
| | Code | | | |
| Decision State | eCredit.com-specific Decision | Char 30 | Y | Decision State list |
| | State | | | |
| Decision Code | Lender assigned code | Char 10 | N | |
| 1 | | | | |
| Decision Code | Lender assigned code | Char 10 | N | |
| 2 | | | | |
| Decision Code | Lender assigned code | Char 10 | N | |
| 3 | | | | |
| Decision Code | Lender assigned code | Char 10 | N | |
| 4 | | | | |
| Decision Code | Lender assigned code | Char 10 | N | |
| 5 | | | | |
| Decision | Lender assigned reason | Char 80 | N | |
| Reason 1 | | | | |
| Decision | Lender assigned reason | Char 80 | N | |
| Reason 2 | | | | |
| Decision | Lender assigned reason | Char 80 | N | |
| Reason 3 | | | | |
| Decision | Lender assigned reason | Char 80 | N | |
| Reason 4 | | | | |
| Decision | Lender assigned reason | Char 80 | N | |
| Reason 5 | | | | |
| Disclaimer Text | The text of the disclaimer for | Char | N | |
| | this credit line | 2000 | | |
| Comment | Comments from the lender to the | Char | N | |
| | merchant or customer | 255 | | |

<list-of-similars-choice>

| | | | | |
|---|---|---|---|---|
| Bureau code | Code name for this bureau | Char 30 | Y | Bureau list |
| Bureau number | Number from the bureau. This | Char 30 | N | |
| | is the file number from Experian | | | |
| | or the DUNS number from Dunn | | | |
| | and Bradstreet | | | |
| Company | Name of the company found | Char 30 | N | |
| Name | | | | |
| Company Address | Address of the company found | Char 30 | N | |
| City | | Char 30 | N | |
| State | | Char 30 | N | |
| Accuracy | Accuracy rating | Numeric | N | |

<lookup-application-criteria>

| | | | | |
|---|---|---|---|---|
| Applicant | Name of the business customer | Char 30 | Y | |
| Name | of merchant | | | |
| Application | An unique id provided by the | Char 10 | N | |
| Number | merchant for the application | | | |
| Lender | An unique id provided by the | Char 10 | N | |
| Application | lender for the application | | | |
| Number | | | | |
| Customer | An unique id for the customer | Char 10 | N | |
| Number | | | | |
| Lender Account | An unique id provided by the | Char 10 | N | |
| Number | lender for the customer | | | |
| Decision | eCredit.com-specific Decision | Char 20 | N | Decision list |
| | Code | | | |
| Decision State | eCredit.com-specific Decision | Char 30 | N | Decision State list |
| | State | | | |
| From | Application Decision status after | Char 20 | N | Format: |
| | this date-time | | | “yyyymmdd hh:mm” |
| To | Application Decision status | Char 20 | N | Format: |
| | before this date-time | | | “yyyymmdd hh:mm” |

<lookup-business-criteria>
Information packet that specifies the criteria for looking up a business customer.

| | | | | |
|---|---|---|---|---|
| Applicant | Name of the merchant's | Char 30 | Y | |
| Name | customer | | | |
| City | | Char 30 | N | |
| State/Province | | Char 10 | N | State Abbreviation |
| | | | | list |

<origination-info>
Information that describes the origination information for this application.

| | | | | |
|---|---|---|---|---|
| Merchant Id | eCredit.com assigned id for the | Char 10 | Y | Valid merchant Id |
| | merchant | | | |
| Application | An unique id provided by the | Char 10 | N | |
| Number | merchant for this application. If | | | |
| | not provided, GFN will create a | | | |
| | unique application number. | | | |
| Channel Type | The type of sales channel (e.g. | Char 20 | N | |
| | direct, web etc) where this | | | |
| | application originated | | | |
| Channel ID | The merchant-assigned identifier | Char 20 | N | |
| | for the specific channel where | | | |
| | this application originated | | | |
| Location Id | The merchant-assigned identifier | Char 20 | N | |
| | of the location (e.g. store or | | | |
| | branch) where the application | | | |
| | originated | | | |
| Sales Rep Id | Merchant assigned id for the | Char 10 | N | |
| | sales representative submitting | | | |
| | this application. | | | |
| Sales Rep | | Char 13 | N | Sales Rep Phone |
| Phone | | | | |
| Sales Rep | | Char 13 | N | |
| Phone | | | | |
| Extension | | | | |
| Sales Rep | The email address for the Sales | Char 40 | N | |
| Email | representative | | | |
| Application | Application specific field for | Char 30 | N | |
| Field 1 | information passed from the | | | |
| | merchant to the lender | | | |
| Application | Application specific field for | Char 30 | N | |
| Field 2 | information passed from the | | | |
| | merchant to the lender | | | |
| Application | Application specific field for | Char 30 | N | |
| Field 3 | information passed from the | | | |
| | merchant to the lender | | | |
| Application | Application specific field for | Char 30 | N | |
| Field 4 | information passed from the | | | |
| | merchant to the lender | | | |
| Application | Application specific field for | Char 30 | N | |
| Field 5 | information passed from the | | | |
| | merchant to the lender | | | |
| Comment | Comments from the merchant or | Char | N | |
| | customer | 255 | | |

<program-option>

| | | | | |
|---|---|---|---|---|
| Program Option | Program option Id for this | Char 30 | Y | Lender or Merchant- |
| Id | financing option. | | | specific |
| Program Option | Program option name for this | Char 30 | Y | Examples: Tech |
| Name | financing option | | | Refresh |
| Term | Lease or loan term for this | Numeric | N | |
| | application, in months | | | |
| Payment | Payment for this lease or loan | Numeric | N | Aggregate lease or loan |
| | | | | payment for the |
| | | | | transaction |
| Rate Factor | Rate factor for this lease or loan | Numeric | N | Expressed as a |
| | | | | decimal. 0.03 is 3% |
| Annual | The APR for this lease or loan | Numeric | N | Expressed as a |
| Percentage Rate | | | | percentage. 20 is 20%. |
| Purchase | The purchase option for the | Char 20 | N | Examples: FMV: Fair |
| Option | equipment | | | Market Value, 10% |
| | | | | Buyout, $1 Buyout |
| Residual | Residual for the equipment | Numeric | N | |
| Down Payment | Number of months of payment | Numeric | N | Integers 0, 1, 2, etc. |
| | applied as a down payment for | | | |
| | this transaction approved | | | |

<support-data>

| | | | |
|---|---|---|---|
| Support Data | The name for this support data | Char 50 | Y |
| Attribute | attribute | | |
| Support Data | The value of the support data | Char | Y |
| Value | | 255 | |

<support-data-reference>

| | | | |
|---|---|---|---|
| Support Data | The source of the support data. | Char 50 | Y |
| Source | | | |
| Support Data | The Id of the event that sourced | Char 30 | Y |
| Event Id | the data | | |

<user-login>

| | | | |
|---|---|---|---|
| Login-id | The user's login identifier | Char 20 | Y |
| Password | The password for this account | Char 20 | Y |
| Private Key | The name of the password file | Char 50 | N |
| File | generated along with the | | |
| | certificate | | |
| Certificate File | The name of the Certificate file | Char 50 | N |
| | generated by eCredit.com to | | |
| | uniquely identify the merchant | | |

What is claimed is:

1. A method for communicating in relation to providing financing services, comprising:
providing definitions for a plurality of types of information packets, each information packet including at least one variable;
defining a purpose for communication between devices in a financing services network;
determining a set of information packets that are to be used to structure the content of a message sent between the devices based on the defined purpose;
defining a value for at least one variable for at least one information packet in the set of information packets; and
sending the message including the set of information packets and the defined value for the at least one variable.

2. The method of claim 1, wherein the step of providing definitions for a plurality of types of information packets comprises:
providing information packet definitions to support a plurality of different communication purposes.

3. The method of claim 2, wherein the plurality of different communication purposes includes at least one of a loan application transaction, a factoring transaction, a trade credit transaction, a leasing transaction, an escrow transaction, a credit insurance transaction, and a letter of credit transaction.

4. The method of claim 1, wherein the step of providing definitions for a plurality of types of information packets comprises:
providing a set of variables for each information packet, wherein the set of variables for each of the plurality of the information packets includes a plurality of variables.

5. The method of claim 1, wherein the step of providing definitions for a plurality of types of information packets comprises:
providing a header information packet that is included in all messages.

6. The method of claim 1, wherein the step of providing definitions for a plurality of types of information packets comprises:
providing definitions for information packets for at least one of a consumer or business address, asset information, a credit bureau report, consumer or business financial information, a credit reference, employment information, equipment information, and a list of alternate identification information for a consumer or business.

7. The method of claim 1, wherein the step of defining a purpose for communications comprises:
defining a set of values that together define the purpose.

8. The method of claim 7, wherein the step of determining a set of information packets comprises:
selecting a set of information packets that correspond to the set of values that define the purpose for communication.

9. The method of claim 1, wherein the step of defining a purpose for communication comprises:
defining values for a plurality of levels in a hierarchy.

10. The method of claim 9, wherein the hierarchy includes levels for at least one of (i) an overall type of financing service to be accessed through the communication, (ii) a type of customer, (iii) type of asset financed, and (iv) credit products available.

11. The method of claim 9, wherein the step of determining a set of information packets comprises:
determining at least one transaction to be executed based on the values defined for the plurality of levels in the hierarchy, where at least one information packet is associated with the execution of the at least one transaction.

12. The method of claim 11, wherein the step of determining at least one transaction comprises:
determining at least one operation that is associated with the at least one transaction to be executed, where the at least one transaction defines a unique set and/or sequence of operations, and at least one information packet is associated with each operation.

13. The method of claim 11, wherein the step of determining the set of information packets comprises:
defining a set of information packets associated with an operation based on at least one of the values for one of the levels in the hierarchy and independent of the at least one transaction.

14. The method of claim 9, wherein the step of defining values for a plurality of levels in a hierarchy comprises:
using input from a user to define the values.

15. A method for communicating in relation to providing financing services, comprising:
providing definitions for a plurality of types of information packets, each information packet including at least one variable;
defining a plurality of values that indicate a purpose for communication between devices in a financing services network;
determining a subset of information packets from the plurality of information packets that are to be used to structure the content of a message sent between the devices based on the defined values indicating the purpose, the subset of information packets including fewer than all of the plurality of information packets for which definitions are provided; and
structuring a message for transmission between the devices using the set of information packets.

16. The method of claim 15, wherein the step of determining a subset of information packets comprises:
selecting a set of information packets that corresponds to the values that define the purpose for communication.

17. The method of claim 15, wherein the step of defining a plurality of values that indicate a purpose for communication comprises:
defining values for a plurality of levels in a hierarchy.

18. The method of claim 17, wherein the hierarchy includes levels for at least one of (i) an overall type of financing service to be accessed through the communication, (ii) a type of customer accessing the financing service, (iii) a type of asset financed, and (iv) credit products available.

19. The method of claim 17, wherein the step of determining a subset of information packets comprises:
determining at least one transaction to be executed based on the values defined for the plurality of levels in the hierarchy, where at least one information packet is associated with the execution of the at least one transaction.

20. The method of claim 19, wherein the step of determining at least one Transaction comprises:
determining at least one operation that is associated with the at least one transaction to be executed, where the at least one transaction defines a unique set and/or sequence of operations, and at least one information packet is associated with each operation.

21. The method of claim 19, wherein the step of determining the subset of information packets comprises:
defining a set of information packets associated with an operation based on at least one of the values for one of the levels in the hierarchy and independent of the at least one transaction.

22. The method of claim 17, wherein the step of defining values for a plurality of levels in a hierarchy comprises:
using input from a user to define the values.

23. A system for accessing financing services within a network, comprising:
a memory that stores definitions for a plurality of types of information packets, each information packet including at least one variable;
a user interface that receives input from a user defining a purpose for communication within the network; and
an Application Programming Interface (API) module that defines the purpose for communication based on the user input and selects a set of information packets that are used to structure a content of messages used for the communication.

24. The system of claim 23, wherein the information packets are arranged to support a plurality of different communication purposes.

25. The system of claim 23, wherein the API module supports a plurality of different communication purposes by using a unique set of information packets for each of the different communication purposes.

26. The system of claim 23, wherein the API module supports communication purposes that include at least one of a loan application transaction, a factoring transaction, a trade credit transaction, a leasing transaction, an escrow transaction, a credit insurance transaction, and a letter of credit transaction.

27. The system of claim 23, wherein a set of variables is provided for each information packet, and a set of variables for each of a plurality of the information packets includes a plurality of variables.

28. The system of claim 23, wherein the API module includes a header information packet in all messages.

29. The system of claim 23, wherein the information packets include at least one of a consumer or business address, asset information, a credit bureau report, consumer or business financial information, a credit reference, employment information, equipment information, and a list of alternate identification information for a consumer or business.

30. The system of claim 23, wherein the user inputs a plurality of values that together define the purpose for communication.

31. The system of claim 30, wherein the API module selects a set of information packets that corresponds to values that define the purpose for communication.

32. The system of claim 23, wherein the user defines values for a plurality of levels in a hierarchy to define the purpose for communication.

33. The system of claim 32, wherein the hierarchy includes levels for at least one of (i) an overall type of financing service to be accessed through the communication, (ii) a type of customer, (iii) type of asset financed, and (iv) credit products available.

34. The system of claim 32, wherein the API module determines at least one transaction to be executed based on the values defined for the plurality of levels in the hierarchy, where at least one information packet is associated with the execution of the at least one transaction.

35. The system of claim 34, wherein the API module determines at least one operation that is associated with the at least one transaction to be executed, where the at least one Transaction defines a unique set and/or sequence of operations, and at least one information packet is associated with each operation.

36. The system of claim 34, wherein the API module defines a set of information packets associated with an operation based on at least one of the values for one of the levels in the hierarchy and independent of the at least one transaction.

37. The system of claim 23, wherein the system is an external computer system that communicates within the network, and the API module is adapted to accommodate a number of financial services that is greater than a number of financial services requested or provided by the external computer system.

38. The system of claim 23, wherein the API module is adapted to accommodate interactive communication between the network and at least one external computer system before a decision to accept or decline a requested financial service has been made.

39. A method of providing financing services, comprising:
defining a plurality of values for levels in a communications interface hierarchy based on user input indicating a financing service to be accessed within a financing network, the communications interface hierarchy including a plurality of levels; and
defining a set of information packets to be included in electronic messages related to the financing service based on the values for levels in the communications interface hierarchy.

40. The method of claim 39, wherein the step of defining a plurality of values comprises:
defining values for levels in a hierarchy for an Applications Programming Interface (API).

41. The method of claim 39, wherein the hierarchy includes a level for at least one of (i) an overall type of financing service, (ii) a type of customer, (iii) type of asset financed, (iv) credit products available, and (v) sets and/or sequences of Transactions to be performed, each Transaction being associated with a set of information packets.

42. The method of claim 39, wherein the hierarchy includes the levels of transactions, operations and information packets and at least one upper level above the transactions, operations and information packets level.

43. The method of claim 42, wherein each item in the transactions level defines a unique set or sequence of operations level items, and at least one information packet is associated with each operations level item.

44. The method of claim 43, wherein at least one information packet level is dependent on a value in the upper level of the hierarchy.

45. The method of claim 39, further comprising:
sending or receiving messages that include a plurality of information packets.

46. A computer system that performs the method of claim 39.

47. A computer readable storage medium including instructions which, when executed, cause a data processing system to perform the method of claim 39.

48. A computer readable storage medium including instructions which, when executed, cause a data processing system to determine a structural content of messages sent between a financial fulfillment network and a remote computer system, the structural content of the messages being determined based on one of a plurality of different financial services supported by an Application Programming Interface (API) that includes a plurality of information packets, and the messages being used to provide a financial service.

49. A method for handling communications related to financing services, comprising:
receiving a communication from at least one computer system external to a financial fulfillment network, the communication being structured based on an Application Programming Interface that is common to all communication between the financial fulfillment network and external computer systems; and
sending a communication to at least one computer system external to the financial fulfillment network that is structured based on the Application Programming Interface.
